(19) United States
(12) Patent Application Publication
(10) Pub. No.: US 2005/0025863 A1
(43) Pub. Date: Feb. 3, 2005

(54) Utensil for drinking and eating, and its manufacturing process

(75) Inventor: Emiko Momose, Gardena, CA (US)

Correspondence Address: REED SMITH LLP, Suite 1400, 3110 Fairview Park Drive, Falls Church, VA, 22042, US

(73) Assignee: E.Y.M. International

(21) Appl. No.: 10/918,437

(22) Filed: Aug. 16, 2004

Related U.S. Application Data
(62) Division of application No. 10/288,449, filed on Nov. 6, 2002, now abandoned.

(30) Foreign Application Priority Data
Nov. 8, 2001 (JP) 2001-379305

(51) Int. Cl. A23G 1/00

(52) U.S. Cl. 426/104

(57) ABSTRACT

To create a utensil for drinking and eating and its manufacturing process even if toothpicks or simple knives or forks are eaten or swayed by livestock by accident, they don't do harm, and if anything, they help livestock's metabolism and health care of the livestock. This is made by four processes as follows: the first process is mixing organic solvent, protein, baking powder, and artificial sweetener (few for each); the second process is-putting the mixture mixed by the previous process into water heated to a certain temperature, and levening it by beating it, then kneading more together with corn starch; the third process is getting the mixture through an extrusion machine kept at constant temperature with casting the mixture into desirable shape by getting it through the mold kept at certain temperature as it is mentioned before; the fourth process is coagulating the mixture by cooling down the utensil for drinking and eating itself shaped by the third process.

### BACKGROUND OF THE INVENTION & SUMMARY OF INVENTION

1. Field of the Invention

The present invention relates to a utensil for drinking and eating made of a harmless substance even if it is eaten by farm animals that can apply to disposable toothpicks, knives, and forks. It also relates to its manufacturing process.

2. Description of the Related Art

Historically, toothpicks and skewers used for various type of pottery have been made of bamboo or wood. In addition disposable “knives”, “forks”, and “spoons” have been generally made of relatively-hard synthetic resins.

Meanwhile, “leftover meals” are generally used as livestock feed as-is.

However, toothpicks or forks said above can be mixed in the leftover meals and eaten coincidentally by the livestock. In this case, these items have had high possibility to pierce “inner mouth”, “esophagus”, and “stomach” of the livestock. Therefore, we have separated house rubbish according to type such as combustible material or non-combustible material, or inadequate material for livestock food, although this process is very difficult to do and hard to separate precisely.

In addition, because disposable “knives”, “forks”, and “spoons” made of synthetic resins are impossible to be festered, the process to handle such industrial waste becomes a big social problem.

As a conclusion of the inventor's extensive trial to find the way to prevent this kind of accident, she finally achieved the utensil for drinking and eating made from healthy substances rather than just a harmless substance, should carelessly be eaten by livestock. She also achieved to suggest its manufacturing process.

Furthermore, the utensil for drinking and eating provided by the present invention can become manure which will contribute for the growth of plants by a process of decay such as disintegration or liquification that takes certain amount of time, even when it is thrown out.

The other characteristic of the present invention is that the body of the utensil for drinking and eating is mainly made of cereal.

The other characteristic of the present invention is that the cereal belongs to a “corn category”.

The other characteristic of the present invention is that the cereal belongs to a “vegetable category” such as tapioca or ocarina.

The other characteristic of the present-invention is that this is made by heating and casting a mixture of 80%˜95% of the corn's starch and certain amount of water and other mixtures.

The other characteristic of the present invention is that this is made by heating and casting a mixture of 80%-95% of starch of the vegetables such as tapioca or ocarina, and certain amount of water and other mixtures.

The other characteristic of the present invention is that the first process is mixing organic solvent, protein, baking powder, and artificial sweetener (few for each); the second process is putting the mixture mixed by the previous process into water heated to a certain temperature, and levening it by beating it, then kneading more together with corn starch; the third process is getting the mixture through an extrusion machine kept at constant temperature with casting the mixture into desirable shape by getting it through the mold kept at certain temperature as it is mentioned before; the fourth process is coagulating the mixture by cooling down the utensil for drinking and eating itself shaped by the third process.

The other characteristic of the present invention is making the same kind of a utensil for drinking and eating as mentioned in the previous section by mixing and working out the previous mixture with “vegetables” such as tapioca, and sweet-potatoes.

In addition, the utensil for drinking and eating of the present invention itself includes cleaning things such as toothpicks used after eating, utensil for beating such as beaters or stirs, devices for eating such as spoons, knives, cups, and dishes, and caddies for soy sauce, and dressing. All of them are within the technical category of the present invention.

### BRIEF DESCRIPTION OF THE DRAWINGS

FIG. 1 is an edge view of mouth cleaning things used after eating.

FIG. 2 is an edge view of beating things used for mixing and beating foods and drinks.

FIG. 3 is an edge view of devices for eating.

FIG. 4 is an edge view of devices for eating and drinking.

FIG. 5 is an edge view of caddies.

### EXPLANATIONS OF SIGNS

A: main unit of the utensil for drinking and eating
11: toothpicks
12: toothpicks with string
13: cotton swab
14: paddles
21: beater
22: beater
23: stir
31: simple spoon
32: simple fork
33: simple knife
41: fulcrums
42: cup
43: dish
44: bowl
45: filter paper
51: caddy of soy sauce, and sauce
52: caddy of dressing

### DESCRIPTION OF THE PREFERRED EMBODIMENTS

The present invention is more specifically explained by means of the following examples, but is not limited only to these examples:
1. First, the first process is mixing uniformly 12% of polyvinyl alcohol as an organic solvent and 0.3˜0.7% of protein, 1˜5% of alum as baking powder, 1˜5% of sorbitol as an artificial sweetener, and 1/5˜1/10 of water.
2. As a second process, putting and beating into gruel the mixture mixed by the first process into water heated by temperatures of around 90 degree centigrade, then adding and beating approximately 90% of corn starch.
3. As a third process, getting the mixture mentioned in the previous section through an extrusion machine kept at temperatures of 130 degree centigrade with casting the mixture into desirable shape by getting it through the mold kept at temperatures of 130 degree centigrade.
4. As a fourth process, coagulating arbitrary goods cast by the third process by putting it into cooling mold whose temperature is kept at around 50 degrees below zero centigrade; this is a completion of process to create a utensil for drinking and eating.

In addition, we could create a utensil for drinking and eating in good condition by substituting “corn starch” for “approximately 90% of tapioca”.

Embodiment 1

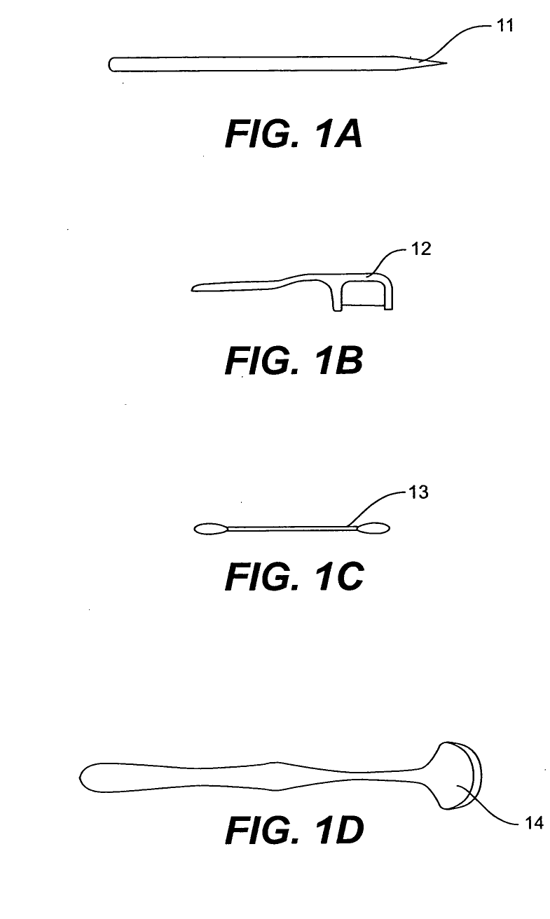

We shaped a utensil for drinking and eating (A) containing vegetables such as corns tapioca, and sweet potato in major proportions obtained by the above processes into a toothpick (11) as shown in FIG. 1. Consequently, the object to clean teeth after eating was achieved sufficiently, and we confirmed no problem occurred when it was given to livestock such as pigs or cows by accident.

In addition, the figure (12) is what we call “toothpicks with string” used to clean between teeth. All part but the string part is made of the utensil for drinking and eating (A) made by the process mentioned before. Also, (13) is what we call “cotton swab” used to clean lugholes. All part but the cotton part is made of the utensil for drinking and eating (A) made by the process mentioned before. (14) is what we call “paddles” used to clean one's tongue. In any case, the function of them is sufficient and it occurs no problem even when it is given to livestock. They become soft within certain time, and finally it becomes perishable as well as regular foods after letting it lay for a long time.

Embodiment 2

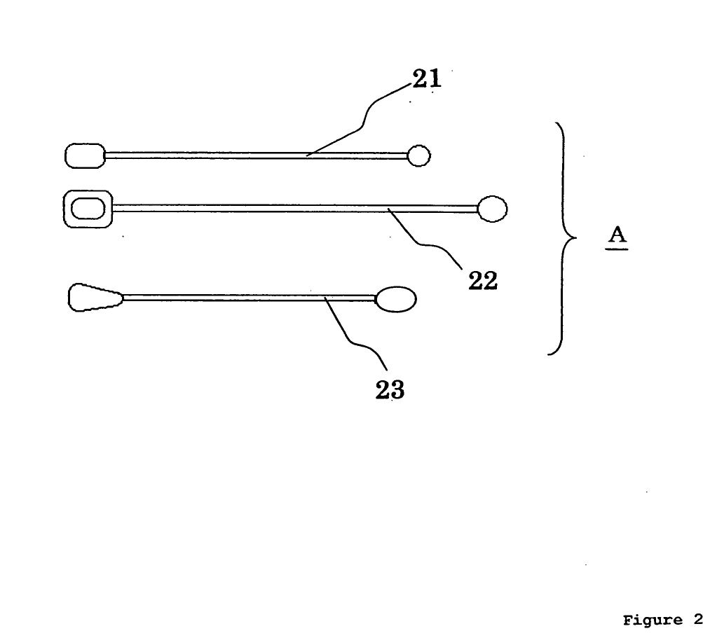

(21) (22) of FIG. 2 are a beater traditionally made of synthetic resins. (23) is what we call “stir”, a utensil for drinking used to beat drinks. We took vegetables such as corn, tapioca, and sweet potato as key ingredient, and joined them to create it. We confirmed beneficial effect as well as previous section.

Embodiment 3

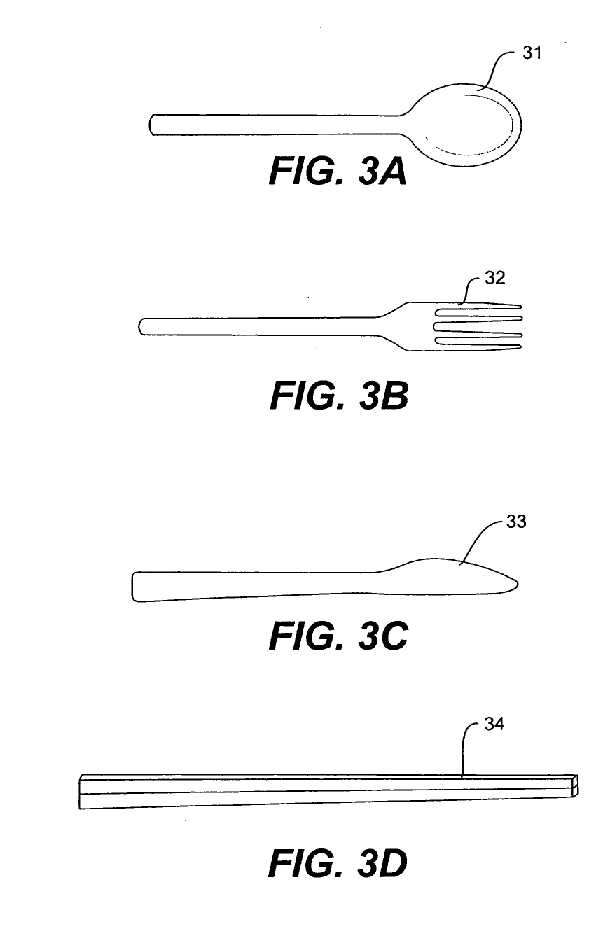

FIG. 3 shows a simple spoon (31), a simple fork (32), and a simple knife (33) traditionally made of synthetic resins or wood. We also took vegetables such as corn, tapioca, and sweet potato as key ingredient, and joined them to create it. We confirmed beneficial effect as well as previous section.

Embodiment 4

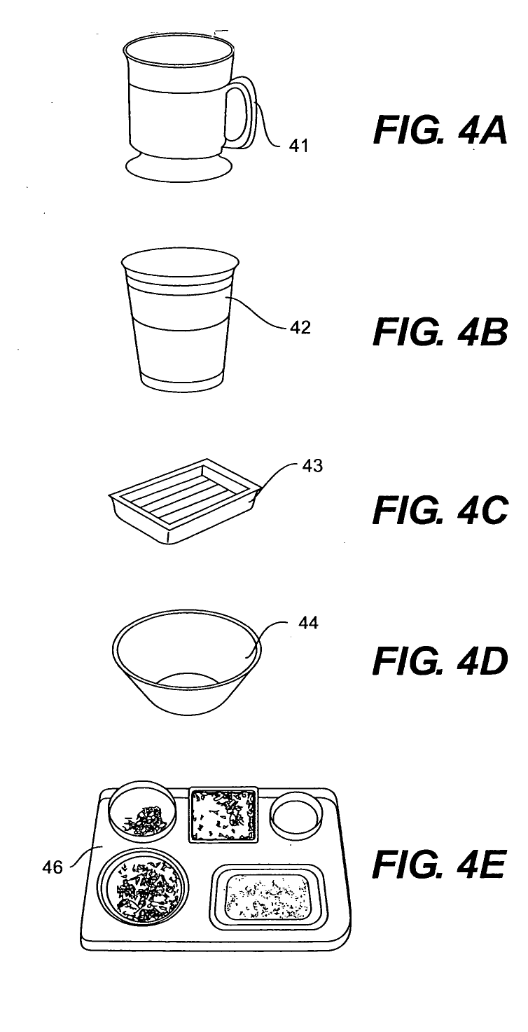

FIG. 4 shows items for eating and drinking traditionally made of synthetic resins or coolite or paper. (41) is a pedestal for cups, (42) is a cup, (43) is a dish, (44) is a bowl, and (45) is a piece of filter paper used for dripping coffee and things like that. Each product corresponds to the object and effect of the present invention.

Embodiment 5

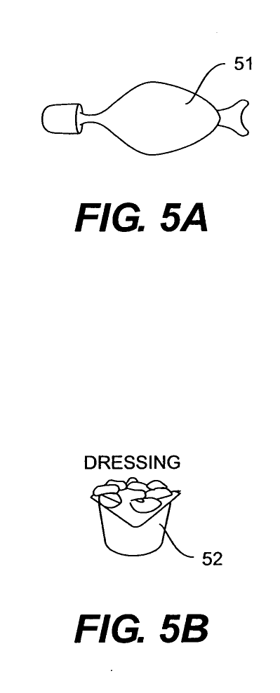

FIG. 5 shows relatively small caddie of sauce or soy sauce (51), and caddies of dressing (52). We took vegetables such as corn, tapioca, and sweet potato as a key ingredient of these products. Consequently, they become product enough to achieve the present invention's object and effect.

Effects of the Invention

As already stated in detail, even if a utensil for drinking and eating such as toothpick or simple knives or forks are eaten by livestock by accident, they don't do harm. If anything, because the utensil is made of starch and includes fiber, the present invention helps livestock's metabolism and health care of the livestock.

In addition, the utensil created by the process of the present invention will be perished by putrefactive bacteria with an elapse of the time even when it is thrown out or thrown out by livestock's bodily function. Therefore, it helps to prevent industrial waste pollution.

In case this is used as manure, of course it helps soil improvement and crop growth.

1-12. (Canceled)

13. A manufacturing process for a utensil for drinking and eating comprising:
a first process of mixing organic solvent, protein, baking powder, and artificial sweetener;
a second process of putting the mixture obtained in the first process into water heated to a certain temperature, and leavening said mixture by beating, then kneading said mixture with 80%˜95% zea starch to obtain an aqueous mixture;
a third process of passing said aqueous mixture obtained in the second process through an extrusion machine kept at constant temperature and casting the mixture into a desirable shape by through a mold kept said constant temperature; and
a fourth process of coagulating said mixture by cooling the utensil itself shaped during said third process.

14. A manufacturing process for a utensil for drinking and eating comprising:
a first process of mixing organic solvent, protein, baking powder, and artificial sweetener;
a second process of putting the mixture obtained in the first process into water heated to a certain temperature, and leavening said mixture by beating, then kneading said mixture with 80%˜95% vegetable starch selected from at least one of tapioca and sweet potatoes to obtain an aqueous mixture;
a third process of passing said aqueous mixture obtained in the second process through an extrusion machine kept at constant temperature and casting the mixture into a desirable shape by through a mold kept said constant temperature; and
a fourth process of coagulating said mixture by cooling the utensil itself shaped during said third process.

15. The manufacturing process according to claim 14, wherein said vegetable starch is selected from at least one of tapioca and sweet potato.
